(19) United States
(12) Patent Application Publication
(10) Pub. No.: US 2005/0044397 A1
(43) Pub. Date: Feb. 24, 2005

(54) Method and system for secure time management in digital rights management

(75) Inventor: Ulf Bjorkengren, Bjarred (SE)

Correspondence Address: BURNS DOANE SWECKER & MATHIS L L P, POST OFFICE BOX 1404, ALEXANDRIA, VA, 22313-1404, US

(73) Assignee: Telefonaktiebolaget LM Ericsson

(21) Appl. No.: 10/643,300

(22) Filed: Aug. 19, 2003

(51) Int. Cl. H04L 9/00

(52) U.S. Cl. 713/200

(57) ABSTRACT

A method and system are described for providing Digital Rights Management-protected (DRM-protected) electronic content to user equipment whose operation is at least in part supported by a platform. When the content is received at a rendering server within the platform, the rendering server requests validation of usage rights associated with the content from a platform DRM module. The DRM module determines whether a DRM content type of the content is associated with a support module in an application domain and, if so, supplies the validation request to the associated support module via an interface with the support module. Otherwise, the validation request is processed at the DRM module. In either case, the content is rendered at the rendering server and made available to the user equipment according to a response to the validation request. The DRM functionality of the support module can be changed by third parties.

### BACKGROUND

The invention relates to electronic content security. More particularly, the invention relates to flexible and secure software solutions for Digital Rights Management of electronic content.

More and more information is transmitted electronically in digital form. Virtually anything that can be represented by words, numbers, graphics, audio information, or a system of commands and instructions can be formatted into electronic digital information. Electronic appliances of various types are all interconnected, providing their users with the potential to accomplish a myriad of tasks, such as telecommunications, financial transactions, business operations, research, and entertainment related transactions.

A fundamental problem for electronic content providers is extending their ability to control the use of proprietary information, such as copyrighted content. Content providers often want to limit the usage of the content to authorized activities and amounts. For example, commercial content providers are concerned with ensuring that they receive appropriate compensation for the use of their content. Unlike analog information, perfect copies of digital information can be made relatively easily and inexpensively if the proper protections are not in place. These copies may then be redistributed illegally, depriving the intellectual property owners and distributors an appropriate compensation.

To this end, content providers and distributors have devised a number of rights protection mechanisms. Among these is Digital Rights Management (DRM). DRM has attempted to address the issue of licensing and controlling distribution of digital content. In general, all DRM systems allow the distribution of digital contents in an encrypted form. A set of rights is associated with the content, and only after acquiring the rights to access a protected piece of digital content will a user be allowed to decrypt it.

DRM content distribution will become even more widespread as more handheld devices, such as cellular telephones and personal digital assistants (PDAs) become DRM-enabled. According to conventional software architecture, as seen from a high level system view, the software for such handheld devices is one monolithic piece. Any change to the software requires a new release of the total software package. A more flexible approach is to divide the software into a platform part, which includes fundamental services and software components that are changed infrequently; and an application part, which includes software components that are more affected by product features and hence need to be changed more often. Accordingly, with a proper partitioning of what is included in the platform domain versus what is included in the application domain, a much simpler, and hence less costly, release process can be achieved. In the following it is assumed that a software architecture having platform and application domains is used.

Current solutions propose DRM function implementation using the conventional software architecture. For example, current DRM solutions propose DRM function implementation within the software contained in the handheld device. More particularly, conventional DRM solutions require the use of a dedicated “DRM player,” such as a browser, media player, and the like.

While these approaches may provide the needed level of security to protect copyrighted material, they have several disadvantages. For example, using this approach, any addition or modification to the DRM functionality requires changes to the software platform. Accordingly, a new DRM function may only be implemented when a new software platform is released, which is a costly and infrequent endeavor. In addition, only the platform software developer can implement the changes and not third parties (e.g., customers of the platform provider that want to tailor the DRM functionality to their specific needs). Finally, the DRM-player solutions generally support only a single DRM standard. This approach therefore offers little or no flexibility. A need exists for a more flexible approach to providing DRM functionality in a software platform.

### SUMMARY

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

In accordance with one aspect of the invention, a system for providing Digital Rights Management-protected (DRM-protected) electronic content to user equipment whose operation is at least in part supported by a platform includes a platform DRM module, a rendering server, an interface to a support module in an application domain, and registration logic. The rendering server receives the DRM-protected content, supplies a corresponding usage right validation request to the DRM module to request validation of usage rights associated with the content, and renders the content according to a response to the usage right validation request. The interface enables the support module and the DRM module to cooperate. The registration logic registers the support module with the DRM module and associates the support module with one or more content types. If the DRM module determines from the usage right validation request that the content is of one of the content types associated with the support module, then the usage right validation request is supplied to the support module and processed by the support module. The usage right validation request may alternatively be processed by the DRM module if the DRM module determines from the usage right validation request that the content is not of one of the content types associated with the support module.

According to another aspect of the invention, a method of providing DRM-protected electronic content to user equipment whose operation is at least in part supported by a platform includes receiving the content at a rendering server and requesting validation of usage rights associated with the content from a platform DRM module. The DRM module determines whether a content type of the content is associated with a support module in an application domain, and, if so, supplies the validation request to the associated support module for processing by the support module cooperatively with the DRM module via an interface with the support module. Otherwise, the validation request is processed at the DRM module. In either case, the content is rendered at the rendering server and made available to the user equipment according to a response to the validation request.

According to further aspects, decryption of the content is done at the DRM module or at the support module, selectively, depending on the registered functionality of the support module. In addition, multiple support modules may each be registered with the DRM module for one or more associated content types, wherein no two support modules are registered for the same content type.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a basic model for providing content using DRM.

FIG. 2 is a block diagram illustrating a first DRM solution according to an aspect of the invention.

FIG. 3 is a block diagram illustrating second and third DRM solutions according to other aspects of the invention.

FIG. 4 is a flow chart illustrating a method for the selective use of the first, second, and third DRM solutions according to another aspect of the invention.

FIG. 5 is a block diagram illustrating a DRM database according to another aspect of the invention.

### DETAILED DESCRIPTION OF THE PREFERRED EMBODIMENTS

Various aspects of the invention will now be described in connection with exemplary embodiments. To facilitate an understanding of these embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both. Moreover, the exemplary embodiments can be considered part of any form of computer readable storage medium having stored therein an appropriate set of computer instructions that would cause a processor to carry out the techniques described herein.

Thus, the various aspects can be embodied in many different forms, and all such forms are contemplated to be within the scope of what is described. For each of the various aspects, any such form of embodiment can be referred to herein as “logic configured to” perform a described action, or alternatively as “logic that” performs a described action.

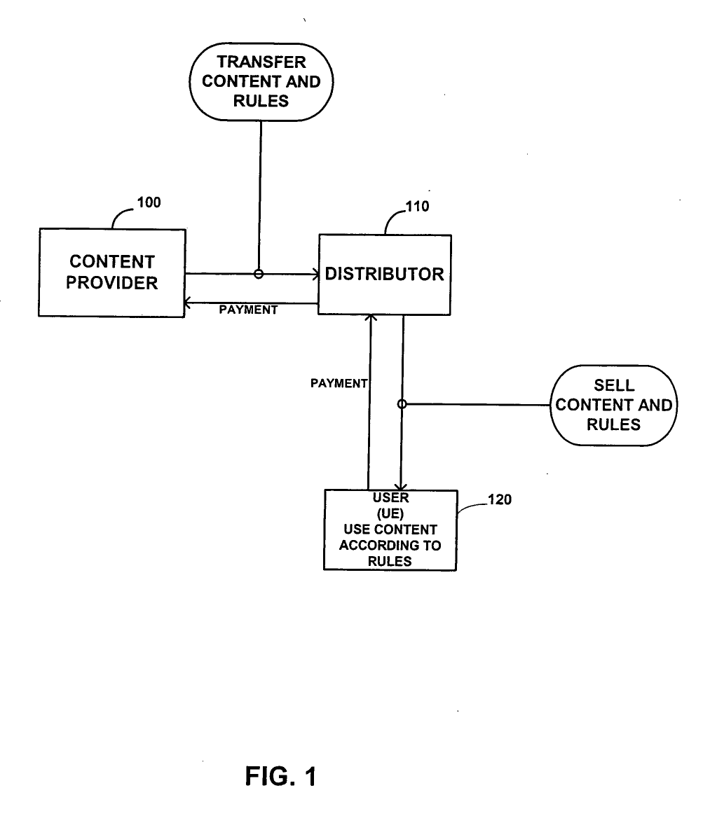

FIG. 1 illustrates an example of a basic model for providing content using DRM. A content provider 100 creates and packages digital content according to the DRM specification and establishes one or more sets of usage rights (or rules) and associated usage costs, which are associated with the various possible uses of the content (e.g., play, print, copy, distribute, etc.) and the allowable number of times, or time period, that the content is made available. The content is transferred to a distributor 110 that makes it available to users 120, for example on a distributor's storefront website. A user 120, operating user equipment (UE), may then browse the distributor's available content and select content of interest to the User 120, while also selecting one of the defined usage rights for the content (noting the associated usage costs). The user 120 makes the appropriate payment to the distributor 110 for the selected content/usage, at which time the content and usage rights can be transferred to the UE, which may be a cellular telephone or other device. The UE can then render the content according to the usage rules to make it available for use by the user 120 according to the usage rules. In some cases the rights are cleared through payment to an intermediary (not shown), such as a payment broker, which then signals the distributor 110 to supply the content.

The DRM related information may be defined generally as two entities—the content container and the license. These entities can be transferred either as one physical package or as two separate physical packages. The latter case is more flexible since a new license can be obtained without resending the entire content and a higher security level is achieved when content and license are not transferred together. If the content container and license are transferred separately, they each must include linking information.

The content container mainly comprises the actual content that the user wants to render, which is in an encrypted form to protect against unauthorized usage. The license is an entity that includes the usage rights of the associated content and the information needed to generate the key needed for content decryption.

As discussed above, the usage rights define the conditions that apply to the rendering of the content. To allow for flexible and extensible expression of the usage rights, special Rights Expression Languages (REL) have been developed. Two of the dominating REL alternatives today are called Extensible Rights Markup Language (XrML) and Open Digital Rights Language (ODRL), both of which are based on Extensible Markup Language (XML).

An encryption/decryption algorithm is employed for encrypting and decrypting the content. The algorithm is preferably symmetric, that is an identical key is used for both operations, for efficiency reasons. The keys themselves, however, can also be protected by using asymmetric ciphering algorithms, which make use of a public/private key pair. Additional security may also be obtained by incorporating the use of certificates and digital signatures, as is known in the art. The complete model for reliable distribution of public keys by using certificates and digital signatures is known as the Public Key Infrastructure (PKI).

As customer demand increases for content availability on more and more types of UE, the platforms that support the UE will need to support DRM. For example, as more content is made available for download on cellular telephones in a given cellular telecommunications system, the specific platform for each telecommunication system must provide some form of DRM support in order to protect the DRM-protected content from unauthorized use. Accordingly, in each case, the platform software will require a DRM component to provide the needed DRM functionality within the platform to process the DRM-protected content.

In general, the DRM component within the platform must provide DRM functionality support within the platform to an outside application (in an application domain) that is providing content to a UE supported by the platform. The DRM functionality that needs to be supported by the component includes downloading support, parsing of files, validation of usage rights, decryption of encrypted content, verification of certificates (including verification of digital signatures), and management of keys, certificates, rights, and licenses.

According to the invention, a number of solutions for providing DRM support within a platform to outside applications are provided. Three of these DRM solutions are discussed below along with some of their associated merits. These solutions are not, however, intended to be mutually exclusive. It will be understood by one of ordinary skill in this art that all the solutions can be employed in a single platform and used selectively according to the requirements of the application.

The term platform refers generally to platform software and hardware that is part of any “secure” network wherein users communicate, via UE, within the network either wirelessly or wired, or any combination of the two, with network entities within the platform which are interfaced to outside applications in the application domain for the purposes of downloading DRM-protected content, among other things. The network is considered secure in the sense that the network platform and communications traffic thereon are managed and controlled by a network provider. As discussed above, there is added flexibility when the software is divided into a platform part, which is in the platform domain, and an application part, which is in the application domain. The partition between the platform and the application domains preferably comprises a minimal and simple interface. Any software requiring type approval procedures, or other sensitive procedures, is preferably located in the platform domain.

An example of such a secure network is a telecommunications system, generally comprising UEs (e.g., cellular telephones) communicating wirelessly to base stations, which in turn communicate with other telecommunication network entities and the like. Included among these other entities is an interface to outside networks, such as the Internet, and outside applications. These outside applications are accessible to users within the network via the various network entities and the software they use to communicate and move data to and from the user (i.e., the platform software) under the control of the network provider. Hereinafter the term platform is used to describe the software and hardware components that at least partly make up such a network.

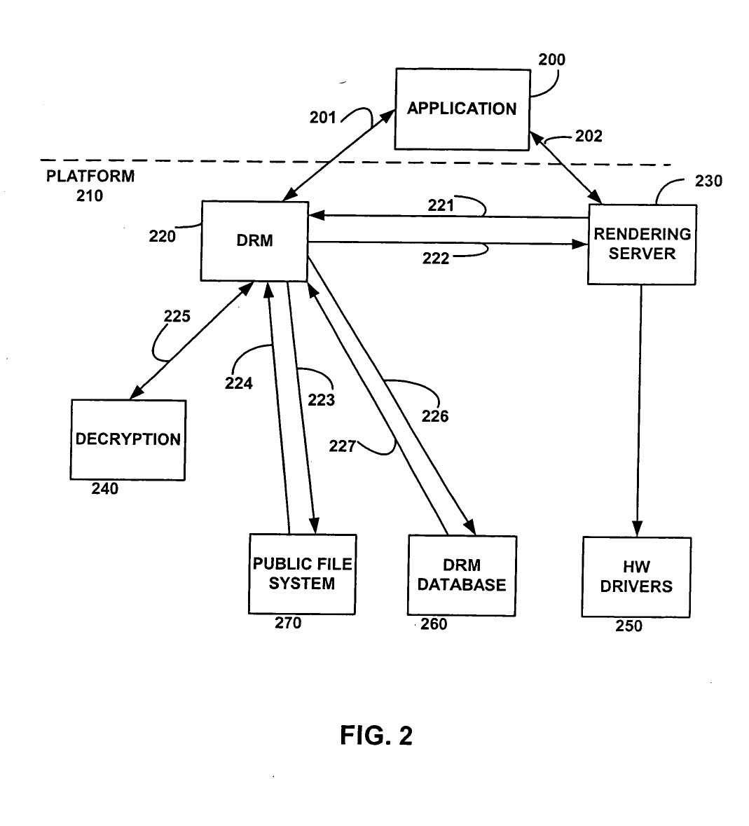

FIG. 2 is a block diagram illustrating a first solution according to the invention, referred to hereinafter as the platform DRM solution. A platform 210 includes a DRM module 220 that provides functionality to manage the processing of DRM-protected content. The DRM module 220 provides the functionality to parse license files, validate the rights associated with DRM-protected content, and to perform other DRM specific procedures. It is not necessary that the DRM module 220 be directly involved in the downloading of DRM-protected content or in the commercial transactions (e.g., browsing, payment, etc.) that proceed downloading. Nevertheless, the DRM module may perform some or all of these functions as well. An application 200 planning to render downloaded DRM protected content communicates 201 with the DRM module 220, for example, through an interface, such as an open platform application program interface (OPA) of the platform 210, to determine the content type based on, for example, multipurpose internet mail extensions (MIME), and the status of the associated usage rights (allowed number of renderings, etc.). The application 200 then supplies 202 the DRM-protected content to a rendering server 230 that corresponds to the type of content. Examples of corresponding rendering servers 230 include an application manager server for executable files, a multimedia control server for downloaded audio or video, a multimedia protocol server for streaming audio or video, and an imaging server for still images and animations.

The rendering server 230 then requests validation 221 of the associated usage rights (i.e., license validation) from the DRM module 220. If the license is invalid or the usage rights otherwise do not allow rendering, the DRM module 220 informs 222 the rendering server 230 and no rendering is performed. If the license is valid and the usage rights allow rendering, the DRM module 220 provides an interface to the rendering server that emulates a standard file system interface, and via this interface the rendering server can access the content in plaintext format without having to know any details of decryption, keys, and the like. Once rendering is successfully initiated, the usage rights are updated by the DRM module 220 to reflect this rendering.

The DRM module 220 must locate and parse the license file(s) associated with the specific DRM-protected content in order to provide the usage rights information to the rendering server 230. As discussed above, the DRM-protected content and the associated license may be sent as a single package or as two separate packages. If a single package is sent, then the DRM module 220 can simply parse the file to retrieve the license. If, however, two separate packages are sent, then the DRM module 220 searches 223 through the public file system 270 in order to find all possible licenses associated with the content (e.g., multiple UE's may each have a license for the same content). In a preferred embodiment, to enable more efficient searches, the application 200 defines a root path indicating where the search should begin.

A DRM database 260 is maintained and updated within an internal file system. When a license associated with the referenced content is either retrieved through parsing (in the single package model) or found in the public file system 270 (in the separate package model), a corresponding record containing information about referenced content file in the DRM database 260 is updated (or created) 226. Each record in the database may comprise, for example, the file name of the content, file names of all licenses associated with the content, and data summarizing all rendering occasions of the content, such as the date and time of each rendering occasion and the number of renderings.

In addition, a decryption key is logically linked to each record in the DRM database 260 for later use in the decryption process. The decryption key may be obtained a number of ways. For example, the key may be stored in the content record, may be acquired with the license file or in a received certificate signed by a trusted authority, may be derived from information in the license together with a information, such as a seed, previously stored in the UE, or may be previously stored entirely within the UE.

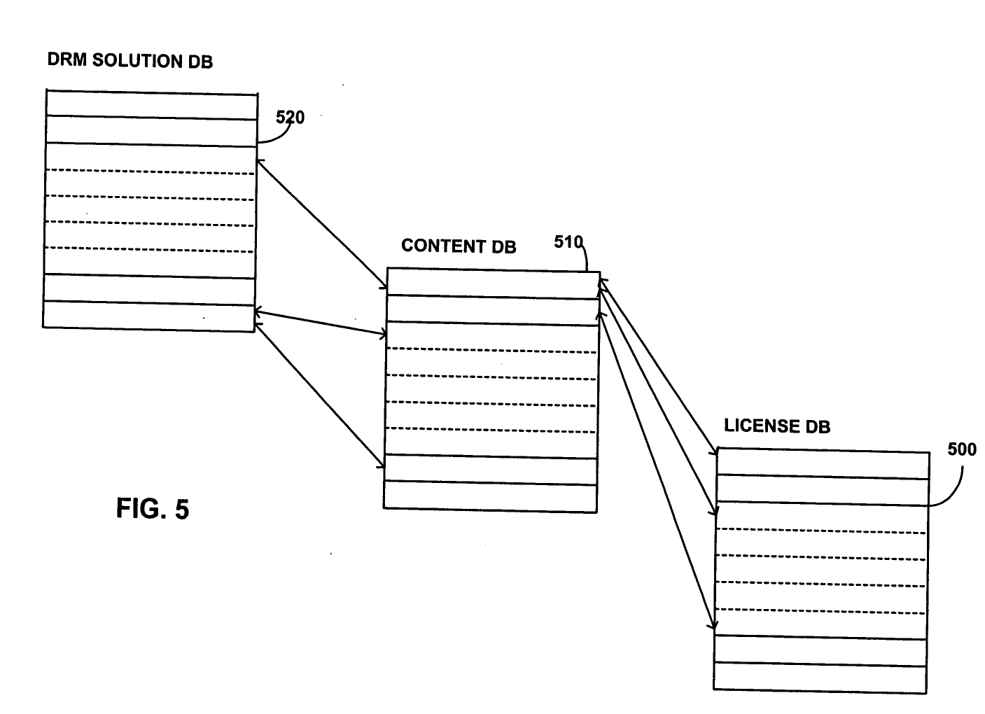

In one aspect, as illustrated in FIG. 5, the DRM database 260 comprises three logically linked databases. A license database 500 is keyed on license file names and comprises, for example, fields for rendering log info, a content file handle (which has a valid value when the content is being rendered according to this license), and an offset into the content file where the encrypted content starts. A content database 510 is keyed on content file names, and comprises, for example, fields for a decryption key, the length of the decryption key, and the name of the cipher. A DRM solution database 520 is keyed on the supported DRM solution names (including support module supported DRM solutions discussed below) and comprises, for example, a bind-ID (specific for support module-supported DRM solutions), a process ID (for registered support modules), and a tag indicating the type of DRM solution.

The databases have the following relationships. One or more records in the license database are associated, or logically linked, with one record in the content database. One or more records in the content database are associated, or logically linked, with one record in the DRM solution database.

During the license validation process, the DRM module 220 searches 226 the DRM database 260 for the corresponding record of the associated content. Each license file listed in the corresponding record is then parsed and the usage rights are evaluated. Upon successful license validation, the corresponding one of the usage rights in the record is selected for use in the rendering process and the DRM module 220 informs the rendering server 230 that the validation was successful. In contrast, when no usage rights are associated with the content, or the usage rights have expired, the DRM module 220 informs the rendering server 230 that no rendering should occur. A simple yes or no command may be sent to the rendering server 230 for this purpose. As can be appreciated, more complex commands that include expressions of the current status of the usage rights may also be used.

Once the usage rights have been evaluated, the rendering process may be carried out accordingly, which includes decryption of the content and the content type specific processing of the content (e.g., audio processing, video processing, etc.), while strictly obeying the associated usage rights. As previously noted, the DRM module 220 supports the rendering server 230 in the decryption process. In a preferred embodiment, the rendering server 230 utilizes the support of DRM module 220 by initiating calls to the DRM module 220 that the rendering server 230 would conventionally make to a file system for a non-DRM-protected file. The DRM module 220 provides support by emulating the functionality of and responding to the conventional file system calls, which may include, open( ), close( ), read( ), seek( ), and tell( ), for example. The DRM module 220 retrieves 225 and utilizes the corresponding decryption algorithm from a secure decryption module 240 in the platform, and decrypts the content, block by block, in response to the file system calls. Alternatively, the decryption can be performed by the decryption module 240 under the supervision of the DRM module 220. A secure internal buffer (not shown) is preferably used for temporarily storing the decrypted content blocks until they can be rendered and used.

The decrypted blocks are supplied to the rendering server 230 for final rendering. It is at this stage that the files are actually consumed (e.g., executed, played, printed, copied, distributed, etc.) according to the usage rights. The rendering server 230 communicates with the associated hardware, such as an LCD screen, using the associated Hardware Driver(s) 250.

The platform DRM solution offers the highest level of security, since all of the UE-related DRM functionality is provided within the platform and away from outside applications that can compromise security. This added security, however, comes at the price of reduced flexibility. The platform software must be updated to support new DRM functions, or altogether new DRM standards. For example, currently there are competing DRM standards, such as Open Mobile Alliance (OMA DRM), Windows Media Device (WM D-DRM), and several others. As these standards evolve, or as new standards are introduced, the platform software would require updating (e.g., a new release). The burden is therefore on the platform provider to undertake continuous updating to maintain up-to-date DRM functionality, which is a costly proposition. No third party providers would be allowed access to the platform software to take on this burden. However, it is these third party providers who are often in the best position to maintain the DRM functionality. Therefore, this solution, which may coexist with the other solutions according to the invention, should preferably be employed only when the highest level of security is required and the DRM standard employed is supported by the current platform release.

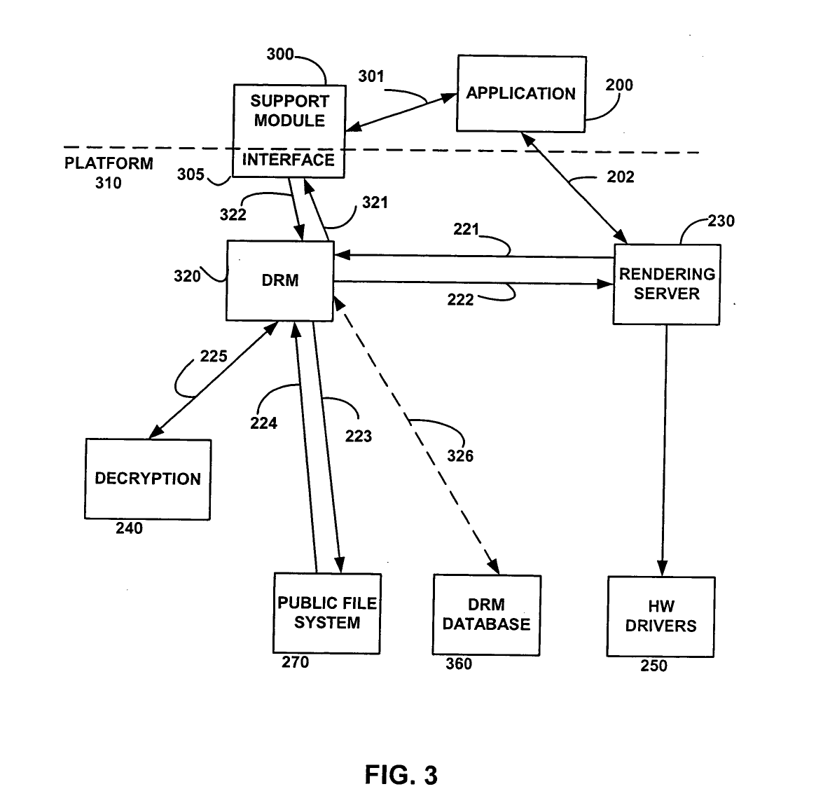

The second and third solutions according to the invention, referred to hereinafter as the partial support module and full support module solutions, respectively, add flexibility through the use of a supporting module that is in an application domain and accessible to third party providers. Referring to FIG. 3, a support module 300 performs some or all of the DRM related tasks, acting in cooperation with a DRM module 320 within the platform. The support module 300 is made accessible to third party provider application developers to add or enhance the DRM functionality.

An interface 305 between the DRM module 320 and the support module 300 enables the cooperation between the modules through the platform boundary. The DRM related tasks are performed through a division of labor between the support module 300 and the DRM module 320, via the interface 305. The tasks performed by the DRM module 320 are primarily independent of the specific DRM standard used by the support module 300. The communications between the DRM module 320 and the support module 300 may be limited to a number of DRM standard specific parameters via the interface 305. For example, the parameters may include the decryption key, the key size, the cipher to be used, and the like.

This approach has two significant advantages. First, no modifications are required to the platform software (i.e., new releases) when changes are made to the DRM functionality. Second, third parties may make changes to the DRM functionality without compromising platform security (since there is no need to access the platform software).

The support module 300 must first register with the DRM module 320. Each support module 300 supports one or more specific DRM standards and a set of associated content file types. A plurality of support modules 300 may register with the same DRM module 320. During registration, the support module 300 is authenticated by the DRM module 320, at which time the DRM module 320 also determines a name, the supported DRM content file types, and the associated DRM standard for the support module 300. The DRM content file types are identified by the file extension associated with the content file. Only one support module 300 may be registered for a given file type.

After successful registration, the DRM module 320 assigns the registered support module 300 a unique bind-ID that is used by the support module 300 in all later communications with the DRM module 320. The DRM module 320 also determines, during registration, which decryption algorithms are to be employed for decrypting the associated content type.

When DRM-protected content matching a registered support module file type is downloaded by the application 200, the DRM module 320 is relegated to the role of managing the non-DRM-specific tasks, such as decryption and rendering. Meanwhile, the support module 300 handles the DRM-specific tasks, such as license management, rights validation, key handling, file parsing, and the like. This division of labor between the DRM module 320 and support module 300 affords the added flexibility with minimal effect on security, since the content is decrypted within the platform. That is, the content remains encrypted until it is safely within the platform domain, where it inherently enjoys a higher security level than it does in the application domain.

According to the partial support module solution, the support module 300 parses protected DRM files, validates the rights associated with protected content, and performs other DRM-specific procedures. The application 200 communicates 301 with the support module 300 to determine the MIME-type of the content and the status of the associated usage rights (allowed number of renderings, etc.). The application 200 then supplies 202 the DRM-protected content to a rendering server 230 that corresponds to the type of content. The rendering server 230 then requests validation 221 of the associated usage rights (i.e., license validation) from the DRM module 320, sending the content file names (with a file extension) with the validation request 221. The DRM module 320, according to the file extension, sends an event signal 321 via the interface 305 to the corresponding registered support module 300. The event signal 321 includes the name of the content file and a request for license validation. The DRM module 320 then awaits a license validation reply 322 from the support module 300 via the interface 305. If the license is invalid or the usage rights otherwise do not allow rendering, the DRM module 320 informs 222 the rendering server 230 and no rendering is performed. If the license is valid and the usage rights allow rendering, the DRM module 320 provides an interface to the rendering server that emulates the file system interface, and via this interface the rendering server can access the content in plaintext format without having to know any details regarding decryption, keys, and the like. Once the rendering is successfully initiated, the usage rights are updated by the DRM module 320 to reflect this rendering.

A DRM database 360 is maintained and updated under the control of the support module 300. The database may be part of the support module 300 or located external to the support module 300 for exclusive or shared access by the support module 300. During the license validation process, the support module 300 searches 326 the DRM database 360 for the corresponding record of the associated content. Each license file listed in the corresponding record is then parsed and the usage rights are evaluated in the support module 300. Upon successful license validation, the corresponding one of the usage rights in the record is selected for use in the rendering process and an indication is provided to the DRM module 320, which informs the rendering server 230 that the validation was successful. In contrast, when no usage rights are associated with the content, or they have expired, the support module 300 informs the DRM module 320, which informs the rendering server 230 that no rendering should occur. A simple yes or no command may be sent to the rendering server 230 as an indication. As can be appreciated, more complex commands that include expressions of the current status of the usage rights may also be used.

Once the usage rights have been evaluated, the rendering process may be carried out accordingly, which includes decryption of the content and the content type-specific processing that must be used on the content (e.g., audio processing, video processing, etc.), while strictly obeying the associated usage rights. As previously noted, the DRM module 320 supports the rendering server 230 in the decryption process. As described above in the platform DRM solution, the rendering server 230 preferably initiates calls to the DRM module 320 that the rendering server 230 would conventionally make to a file system for a non-DRM-protected file. The DRM module 320 retrieves 225 and utilizes the corresponding decryption algorithm (as indicated by the support module 300 during registration) from a secure decryption module 240 in the platform, and decrypts the content, block by block, in response to the file system calls. Alternatively, the decryption can be performed by the decryption module 240 under the supervision of the DRM module 320. A secure internal buffer (not shown) is preferably used for temporarily storing the decrypted content blocks until they can be rendered and used. The decrypted blocks are supplied to the rendering server 230 for final rendering. When the DRM module 320 supervises the decryption, the DRM module 320 first retrieves 223, 224 appropriate parts of the encrypted content file using the public file system 270, then forwards this data for decryption by the decryption module 240.

According to the full support module solution, when DRM-protected content matching a registered support module file type is downloaded by the application 200, the DRM module 320 is relegated to the role of a pass-through conduit for communication to and from the support module 300 via the interface 305. During registration, the support module 300 employing the full support module solution informs the DRM module 320, by a simple command, that all functionality will be managed by the support module 300, including the non-DRM-specific tasks, such as decryption and rendering. The decryption may be carried out by the support module 300, using its own decryption engine, or by the decryption module 240 under the supervision of the support module 300 via the DRM module 320. The support module 300 also handles the DRM-specific tasks, such as license management, rights validation, key handling, file parsing, and the like. The DRM module 321 simply directs the information to the appropriate entities within the platform as needed. This arrangement provides maximum flexibility in return for diminished security, since the content is decrypted outside the platform, that is, decrypted content is available outside the platform domain in the application domain.

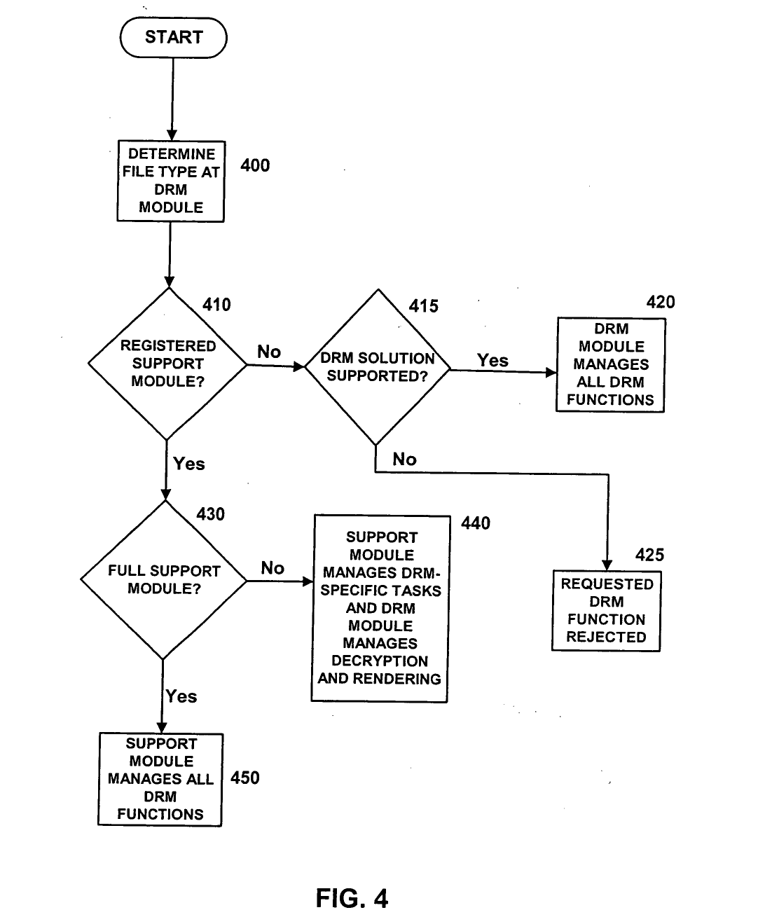

As previously noted, the three solutions for providing DRM support discussed above need not be mutually exclusive. More particularly, all the solutions can be employed in a single platform and used selectively according to the requirements of the DRM standard and the associated file types. FIG. 4 is a flow chart illustrating a method for the selective use of the first, second, and third DRM solutions according to this aspect of the invention. Referring to FIG. 4, once the file type is determined by the DRM module (step 400), the DRM module determines if a support module is registered for the specific file type (step 410). If no corresponding support module is registered, the DRM module checks to determine if the particular DRM solution is supported by the DRM module (step 415). If the particular DRM solution is supported by the DRM module, the DRM module manages all DRM functions according to the platform support solution described above (step 420). If the particular DRM solution is not supported by the DRM module, the requested DRM function is rejected.

If, however, a support module is registered for the specific file type (step 410), then the DRM module determines whether or not the registered support module is a full support module (step 430). Depending on whether or not the support module is a full support module, the full support module solution (step 450) or the partial support module solution (step 440), respectively, is employed.

It will be appreciated by those of ordinary skill in the art that the invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A system for providing Digital Rights Management-protected (DRM-protected) electronic content to user equipment whose operation is at least in part supported by a platform, the system comprising:
a platform DRM module;
a rendering server for receiving the DRM-protected content and supplying a corresponding usage right validation request to the DRM module to request validation of usage rights associated with the content, and for rendering the content according to a response to the usage right validation request;
an interface for enabling the DRM module to cooperate with a support module in an application domain; and
registration logic that registers the support module with the DRM module and associates the support module with one or more content types,
wherein if the DRM module determines from the usage right validation request that the content is of one of the content types associated with the support module, then the usage right validation request is supplied to the support module and processed by the support module.

2. The system of claim 1, wherein when the content type is not associated with a registered support module, the usage right validation request is processed by the DRM module.

3. The system of claim 2, wherein the DRM module parses a license file corresponding to the content to determine the usage rights when processing the validation request.

4. The system of claim 1, further comprising the support module, and wherein the support module parses a license file corresponding to the content to determine the usage rights when processing the validation request.

5. The system of claim 1, wherein the DRM module provides a validation reply to the rendering server to indicate whether or not the usage rights are successfully validated.

6. The system of claim 5, wherein the DRM module further comprises decryption means, and the rendering server, upon receiving a validation reply indicating a successful validation, supplies the content to the DRM module for decryption, receives decrypted content back from the DRM module, and renders the decrypted content, the rendered decrypted content being made available to the user equipment for use according to the associated usage rights.

7. The system of claim 5, further comprising the support module, wherein the support module further comprises decryption means, and the rendering server, upon receiving a validation reply indicating a successful validation, supplies the content to the support module for decryption, receives decrypted content back from the support module, and renders the decrypted content, said rendered decrypted content being made available to the user equipment for use according to the associated usage rights.

8. The system of claim 1, further comprising a plurality of support modules each being registered with the DRM module for one or more associated content types, wherein no two support modules are registered for the same content type.

9. The system of claim 1, wherein, when the DRM-protected content is determined by the DRM module to be one of the associated content types, the DRM module sends an event signal that comprises the name of the content file and a request for license validation.

10. The system of claim 9, wherein the event signal further comprises a request for a decryption key.

11. The system of claim 1, further comprising a database for storing and updating records corresponding to the associated usage rights, said database being accessible to either or both of the DRM module and the support module for managing usage rights.

12. The system of claim 11, wherein one or more corresponding decryption keys for use in decrypting the content are logically linked to each record in the database.

13. A method of providing DRM-protected electronic content to user equipment to user equipment whose operation is at least in part supported by a platform, the method comprising the steps of:
receiving, at a rendering server, the DRM-protected content;
requesting, by the rendering server, validation of usage rights associated with the content from a DRM module within the platform;
determining whether a content type of the content is associated with a support module in an application domain;
supplying, whenever the content type is associated with a support module, the validation request to the associated support module by the DRM module for processing by the support module cooperatively with the DRM module via an interface with the support module;
processing, whenever the content type is not associated with a support module, the validation request at the DRM module;
responding, by the DRM module, to the validation request; and
rendering the content according to the validation response.

14. The method of claim 13, wherein, when the validation response indicates a successful validation, the step of rendering further comprises:
supplying the content to the DRM module for decryption;
receiving and rendering the decrypted content at the rendering server; and
providing the rendered decrypted content to the user equipment for use according to the associated usage rights.

15. The method of claim 13, wherein, when the validation response indicates a successful validation, the step of rendering further comprises:
supplying the content to the support module for decryption;
receiving and rendering the decrypted content at the rendering server; and
providing the rendered decrypted content to the user equipment for use according to the associated usage rights.

16. The method of claim 13, comprising the preliminary step of registering the support module with the DRM module, the registration providing, to the DRM module, a list of one or more DRM content types associated with the support module.

17. The method of claim 16, wherein the step of registering the support module further comprises providing, to the DRM module, a list of DRM functions to be performed by the support module, the list selectively including decryption of DRM-protected files.

18. The method of claim 13, wherein processing the validation request, by either the support module or the DRM module, includes parsing a license file corresponding to the content to determine the usage rights.

19. The method of claim 13, wherein the step of supplying the validation request to the associated support module comprises sending an event signal that comprises the name of the content file and a request for license validation.

20. The method of claim 19, wherein the event signal further comprises a request for a decryption key.

21. The method of claim 13, further comprising the step of maintaining a database for storing and updating records corresponding to the associated usage rights.

22. The method of claim 21, wherein one or more corresponding decryption keys used for decrypting the content are logically linked to each record in the database.
